(19) United States
(12) Patent Application Publication
(10) Pub. No.: US 2021/0149721 A1
(43) Pub. Date: May 20, 2021

(54) INFORMATION PROCESSING SYSTEM, INFORMATION PROCESSING APPARATUS, AND NON-TRANSITORY COMPUTER READABLE MEDIUM STORING PROGRAM

(71) Applicant: FUJI XEROX CO., LTD., Tokyo (JP)

(72) Inventor: Taro TAKASHIMA, Kanagawa (JP)

(73) Assignee: FUJI XEROX CO., LTD., Tokyo (JP)

(21) Appl. No.: 16/892,303

(22) Filed: Jun. 4, 2020

(30) Foreign Application Priority Data
Nov. 18, 2019 (JP) 2019-207600

(51) Int. Cl. G06F 9/48; G06F 9/451; H04L 29/08

(52) U.S. Cl. CPC G06F 9/4881; H04L 67/06; G06F 9/451; G06F 9/485

(57) ABSTRACT

An information processing system includes a task information acquisition section that acquires task information being information on an individual task performed by a tasker, a detection section that detects specific task information being task information indicating a specific task, from a plurality of pieces of the task information acquired by the task information acquisition section, and a selection section that selects task information from the plurality of pieces of the task information acquired by the task information acquisition section, based on the specific task information detected by the detection section.

### CROSS-REFERENCE TO RELATED APPLICATIONS

This application is based on and claims priority under 35 USC 119 from Japanese Patent Application No. 2019-207600 filed Nov. 18, 2019.

### BACKGROUND

### (i) Technical Field

The present invention relates to an information processing system, an information processing apparatus, and a non-transitory computer readable medium storing a program.

### (ii) Related Art

JP2011-086023A discloses processing in which, in a case where a target file is searched for, a user selects a desktop space image associated with the target file from a plurality of desktop space images which have been initially displayed, the selected desktop space image is displayed, and the target file is selected from pieces of metadata related with the displayed desktop space image.

JP5496896B discloses processing in which, in order to acquire a sequence of a related event in data, a request expression is parsed, and dependency between searched events and a constraint condition (for example, keyword) characterizing each event are obtained.

### SUMMARY

In a case where a user attempts to perform a task, the user may check a procedure and the like of the task to be performed with reference to the history of tasks which have been previously performed. Here, in a case where the amount of information on the history of tasks is too large, the information becomes excessive, and thus checking the procedure and the like of the task has difficulty.

Aspects of non-limiting embodiments of the present disclosure relate to an information processing system, an information processing apparatus, and a non-transitory computer readable medium storing a program that facilitate referring to information on the previous task more than a case where information on the previous task is not narrowed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a task information acquisition section that acquires task information being information on an individual task performed by a tasker, a detection section that detects specific task information being task information indicating a specific task, from a plurality of pieces of the task information acquired by the task information acquisition section, and a selection section that selects task information from the plurality of pieces of the task information acquired by the task information acquisition section, based on the specific task information detected by the detection section.

### BRIEF DESCRIPTION OF THE DRAWINGS

Exemplary embodiment(s) of the present invention will be described in detail based on the following figures, wherein:

FIG. 1 is a diagram illustrating an information processing system;

FIG. 2 is a diagram illustrating a configuration of a terminal apparatus;

FIG. 3 is a diagram illustrating a configuration of an external server;

FIG. 4 is a block diagram illustrating functions of an external server;

FIG. 5 is a diagram illustrating a display screen displayed on a terminal apparatus of a tasker;

FIG. 6 is a flowchart illustrating a flow of processing performed in a case where the external server specifies a specific task;

FIG. 7 is a diagram illustrating an example of task information stored in an information storage unit;

FIG. 8 is a diagram illustrating a display screen displayed on the terminal apparatus of the tasker in a case where task information on the tasker is output to a referrer who refers to the task information;

FIG. 9 is a diagram illustrating a display screen displayed on a terminal apparatus of the referrer;

FIG. 10 is a flowchart illustrating a flow of processing performed in a case where processing of searching for the task information is performed;

FIG. 11 is a flowchart illustrating a flow of processing performed in a case where task information selected by a user is deleted; and

FIG. 12 is a diagram illustrating another example of the display screen displayed on the terminal apparatus.

### DETAILED DESCRIPTION

Hereinafter, an exemplary embodiment of the present disclosure will be described with reference to the accompanying drawings.

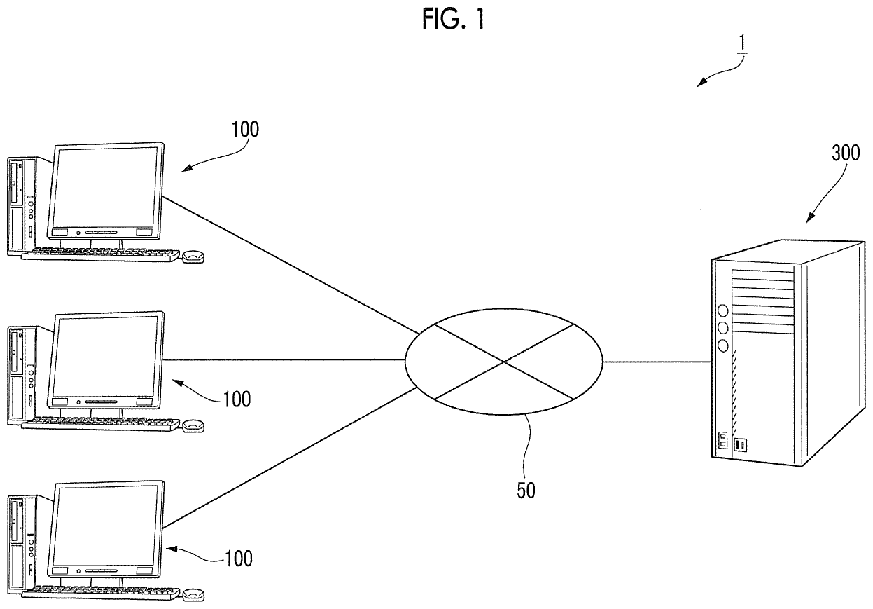

FIG. 1 is a diagram illustrating an information processing system 1 according to the exemplary embodiment.

In the exemplary embodiment, a plurality of terminal apparatuses 100 operated by users are provided in the information processing system 1. An external server 300 that performs processing for task information being information on a task performed by a tasker is provided in the information processing system 1.

The terminal apparatus 100 and the external server 300 are configured by computer devices. The terminal apparatus 100 and the external server 300 are connected to a communication line 50 such as the Internet. In the exemplary embodiment, the plurality of terminal apparatuses 100 and the external server 300 are connected to each other via the communication line 50.

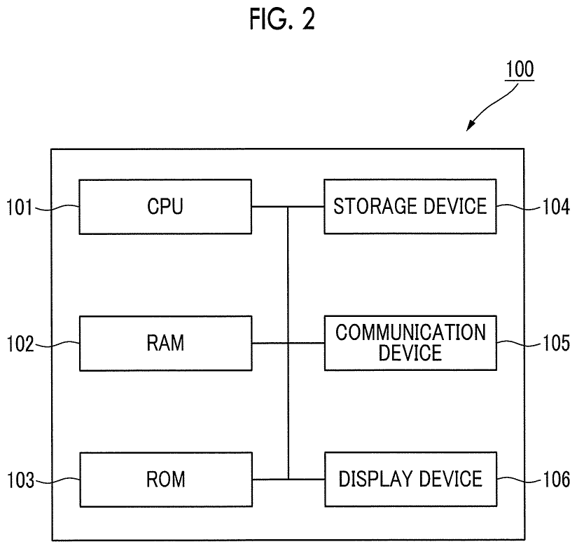

FIG. 2 is a diagram illustrating a configuration of the terminal apparatus 100.

Each of the terminal apparatuses 100 includes a central processing unit (CPU) 101 as an example of a processor, a random access memory (RAM) 102, a read only memory (ROM) 103, a storage device 104 configured by a hard disk drive and the like, and a communication device (communication I/F) 105 that communicates with an outside of the terminal apparatus.

Each of the terminal apparatuses 100 includes a display device 106 that displays information. The display device 106 is configured by, for example, a liquid crystal display. Although not illustrated, the terminal apparatus 100 includes an input device such as a keyboard and a mouse.

The ROM 103 and the storage device 104 store programs executed by the CPU 101. The CPU 101 reads a program stored in the ROM 103 or the storage device 104 and executes the program using the RAM 102 as a work area.

Various functions are realized by the CPU 101 executing the programs stored in the ROM 103 and the storage device 104.

Here, the program to be executed by the CPU 101 is stored in a computer-readable recording medium such as a magnetic recording medium (such as a magnetic tape or a magnetic disk), an optical recording medium (such as an optical disk), a magneto-optical recording medium, or a semiconductor memory. In this state, the program may be provided for the terminal apparatus 100. The program to be executed by the CPU 101 may be provided for the terminal apparatus 100 using a communication section such as the Internet.

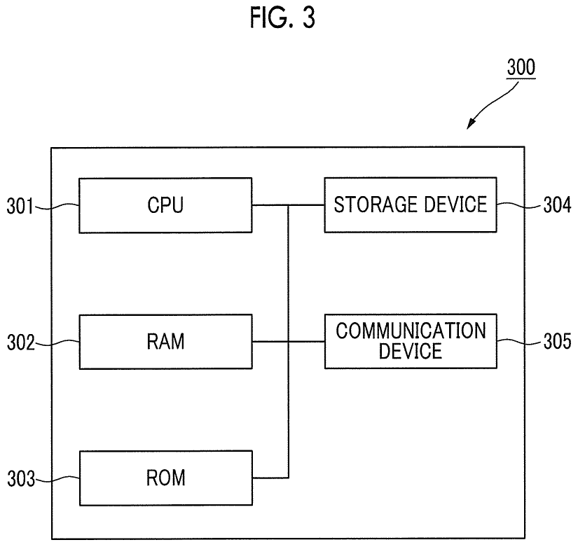

FIG. 3 is a diagram illustrating a configuration of the external server 300.

The external server 300 includes a central processing unit (CPU) 301 as an example of a processor, a random access memory (RAM) 302, a read only memory (ROM) 303, a storage device 304 configured by a hard disk drive and the like, and a communication device (communication I/F) 305 that communicates with an outside of the terminal apparatus.

The external server 300 includes an input device such as a keyboard and a mouse and a display device that displays information, as necessary. The display device is configured by, for example, a liquid crystal display.

The ROM 303 and the storage device 304 store programs executed by the CPU 301. The CPU 301 reads a program stored in the ROM 303 or the storage device 304 and executes the program using the RAM 302 as a work area.

Functional units described later are realized by the CPU 301 executing the programs stored in the ROM 303 and the storage device 304.

Here, the program to be executed by the CPU 301 is stored in a computer-readable recording medium such as a magnetic recording medium (such as a magnetic tape or a magnetic disk) , an optical recording medium (such as an optical disk), a magneto-optical recording medium, or a semiconductor memory. In this state, the program may be provided for the external server 300. The program to be executed by the CPU 301 may be provided for the external server 300 using a communication section such as the Internet.

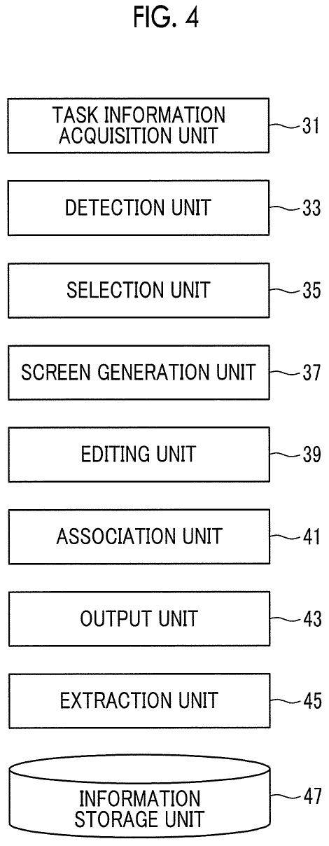

FIG. 4 is a block diagram illustrating functions of the external server 300.

The external server 300 includes a task information acquisition unit 31, a detection unit 33, a selection unit 35, a screen generation unit 37, an editing unit 39, an association unit 41, an output unit 43, an extraction unit 45, and an information storage unit 47.

Here, the functional units other than the information storage unit 47 are realized by the CPU 301 executing a program stored in the ROM 303 or the storage device 304. The information storage unit 47 is realized by the storage device 304.

In the exemplary embodiment, a case where the functional units are provided in the external server 300 as an example of an information processing apparatus is described. However, a plurality of information processing apparatuses are prepared, and the functional units may be provided to be distributed to the plurality of information processing apparatuses. In this case, an information processing system is configured by the plurality of information processing apparatuses, and these functional units are realized by the information processing system.

Here, the task information acquisition unit 31 as an example of a task information acquisition section acquires task information that is information on an individual task performed by a tasker.

The detection unit 33 as an example of a detection section detects specific task information that is task information indicating a specific task, from a plurality of pieces of task information acquired by the task information acquisition unit 31.

The selection unit 35 as an example of a selection section selects task information from a plurality of pieces of task information acquired by the task information acquisition unit 31, based on the specific task information detected by the detection unit 33.

The screen generation unit 37 as an example of a screen generation section generates a display screen on which the task information selected by the selection unit 35 is displayed.

The editing unit 39 as an example of an editing section edits the task information acquired by the task information acquisition unit 31.

The association unit 41 as an example of an association section associates information input by a user with the task information acquired by the task information acquisition unit 31.

The output unit 43 as an example of an output section outputs the task information selected by the selection unit 35. More specifically, the output unit 43 controls the communication device 305 to output the task information selected by the selection unit 35.

The extraction unit 45 as an example of an extraction section extracts task information corresponding to a task to be performed next time by the tasker, from pieces of the task information selected by the selection unit 35.

The information storage unit 47 performs storing of various kinds of information such as storing of task information.

In the exemplary embodiment, in a case where a tasker operates the own terminal apparatus 100 to perform a task, task information that is information on the task is transmitted to the external server 300 from the terminal apparatus 100, and the external server 300 acquires the task information.

More specifically, in the exemplary embodiment, task information that is information on an individual task performed by the tasker is transmitted to the external server 300, and the task information acquisition unit 31 provided in the external server 300 acquires the task information.

The task information acquired by the task information acquisition unit 31 is sequentially stored and accumulated in the information storage unit 47.

In other words, in the exemplary embodiment, in a case where the tasker operates the own terminal apparatus 100, operation information that is information on the operation is transmitted from the terminal apparatus 100 to the external server 300. The external server 300 acquires the operation information, and the operation information is stored in the information storage unit 47.

In storing the task information in the information storage unit 47, in addition to the task information itself, a task time point at which the task has been performed, the name of a tasker who has performed the task (information of specifying the tasker who operates the terminal apparatus 100), information indicating the type of task, information indicating whether the task is a termination task (described later), and the like are stored in the information storage unit 47 in a state of being associated with the task information.

In the exemplary embodiment, the tasker may operate the own terminal apparatus 100 to search for, for example, information on a task performed by the tasker in the past.

In the exemplary embodiment, as will be described later, a case where a tasker A searches for information on a task performed by the tasker A in the past will be described as an example.

In this search, the tasker A firstly operates the own terminal apparatus 100 to input a keyword which is an example of input information. The keyword is transmitted to the external server 300.

At this time, tasker information that is information on the tasker A is also transmitted to the external server 300.

More specifically, in the exemplary embodiment, in the terminal apparatus 100 operated by the tasker A, user authentication is performed, and thus an operator who operates the terminal apparatus 100 is recognized to be the tasker A. Then, information on the tasker A is transmitted to the external server 300.

Then, in the exemplary embodiment, the detection unit 33 in the external server 300 detects specific task information that is task information indicating a specific task, from a plurality of pieces of task information stored in the information storage unit 47.

Then, in the exemplary embodiment, the selection unit 35 selects task information from a plurality of pieces of task information stored in the information storage unit 47, based on the specific task information detected by the detection unit 33, the keyword input by the tasker A, and the information which is tasker information and indicates the tasker A.

In the exemplary embodiment, a case where task information is selected based on the specific task information detected by the detection unit 33, the keyword input by a user, and the tasker information will be described, but selection processing by the selection unit 35 is not limited to the above case.

Alternatively, the selection unit 35 may select task information based on the specific task information and the tasker information without considering the keyword. In addition, the selection unit 35 may select task information based on only the specific task information without considering the keyword and the tasker information.

In a case where the keyword and the tasker information are not considered, the number of pieces of extracted task information increases. However, because the task information is selected and extracted, and the tasker may refer to the extracted task information to more efficiently perform a task to be performed afterward (details will be described later).

Then, in the exemplary embodiment, the screen generation unit 37 generates a display screen on which the task information selected by the selection unit 35 is displayed.

In the exemplary embodiment, the generated display screen is transmitted to the terminal apparatus 100 of the tasker A, and the display screen generated by the screen generation unit 37 is displayed on the terminal apparatus 100 of the tasker A.

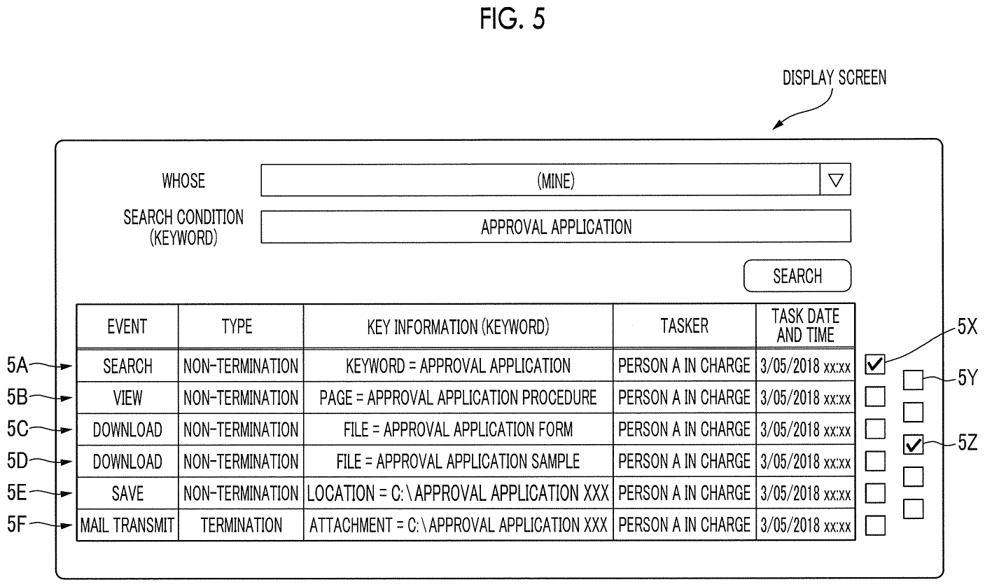

FIG. 5 is a diagram illustrating the display screen displayed on the terminal apparatus 100 of the tasker A.

On the display screen, as indicated by the reference signs 5A to 5F, six pieces of task information, which are information on an individual task performed by the tasker A in the past and is related to a keyword “approval application”, are displayed in a state of being arranged in chronological order.

In the example illustrated in FIG. 5, for each piece of task information, an event name indicating the type of task information, type information indicating whether a task specified by the task information is a termination task or a non-termination task, key information that is information corresponding to the keyword “approval application” among pieces of information associated with each piece of task information, the name of a tasker who has performed the task, and task date and time of the task are displayed.

Here, the detection unit 33 in the exemplary embodiment detects task information indicating a task of transmitting a document to the outside among a plurality of pieces of task information acquired by the task information acquisition unit (plurality of pieces of task information stored in the information storage unit 47), as specific task information.

In other words, the detection unit 33 detects task information indicating a task of transmitting an electronic mail to be transmitted with an attached document among a plurality of pieces of task information acquired by the task information acquisition unit 31, as the specific task information.

In addition, the detection unit 33 determines that the task of transmitting a document to the outside is a termination task performed at the end of a series of a plurality of tasks. Then, the detection unit 33 detects task information of the task of transmitting a document to the outside, as the specific task information.

Specifically, for example, in an application task, after searching for an application document, searching for procedures required for the application, downloading the application document, saving the completed document, and the like are performed, finally, the completed document may be attached to an electronic mail and transmitted.

In the exemplary embodiment, a transmission task by the electronic mail is detected by the detection unit 33. Thus, in the exemplary embodiment, it is detected that a series of tasks related to an application has been completed.

Then, in the exemplary embodiment, the selection unit 35 selects task information corresponding to a task performed before a task specified by the specific task information detected by the detection unit 33, from the plurality of pieces of task information stored in the information storage unit 47.

More specifically, the selection unit 35 selects task information corresponding to a task performed before the task of transmitting an electronic mail, which is detected by the detection unit 33, from the plurality of pieces of task information stored in the information storage unit 47.

Then, the screen generation unit 37 generates a display screen based on the task information selected by the selection unit 35, and the generated display screen is displayed on the terminal apparatus 100 of a tasker.

As a result, in the exemplary embodiment, as illustrated in FIG. 5, the task information selected by the selection unit 35 is displayed on the terminal apparatus 100 of the tasker.

On the display screen, task information on mail transmission, that is specific task information, is displayed at the bottom. As indicated by the reference signs 5A to 5E, five pieces of task information corresponding to tasks performed before the mail transmission are displayed above the mail transmission.

Here, in a case where a tasker attempts to perform a task from now, the tasker may check a procedure and the like of the task to be performed with reference to the history of tasks which have been previously performed.

In the exemplary embodiment, as described above, information on a series of tasks performed by the tasker in the past is displayed, and the tasker may check a procedure and the like of a task performed from now, by referring to the displayed information.

In the above description, a case where the task information of the task of transmitting a document to the outside is detected as the specific task information has been described as an example. However, the exemplary embodiment is not limited to the above case, and task information of another task may be detected as the specific task information.

For example, in an application task, at the beginning of the task, searching for an application document, and downloading the application document may be performed. However, task information of the search task or the download task may be detected as the specific task information.

As described above, in a case where the task information of the task performed at first is set as the specific task information, the selection unit 35 selects task information corresponding to a task performed after the task specified by the specific task information.

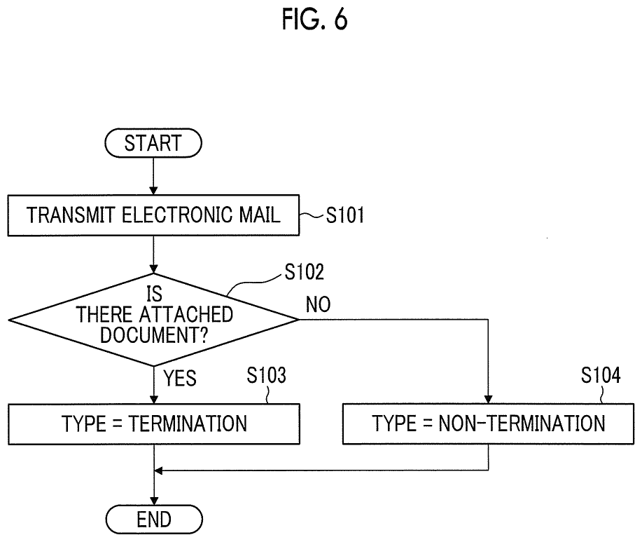

FIG. 6 is a flowchart illustrating a flow of processing performed in a case where the external server 300 specifies a specific task.

In the exemplary embodiment, for example, in a case where a user performs a task of transmitting an electronic mail (Step S101), task information that is information on the task is transmitted to the external server 300, and the external server 300 acquires the task information.

Then, the external server 300 determines whether or not the electronic mail has an attached document (Step S102).

In a case where the external server 300 determines that there is an attached document, the external server 300 determines that the transmission task of the electronic mail to which the attached document is attached is the specific task.

In this case, the external server 300 attaches information of “termination” to the task information of the transmission task of the electronic mail, which is stored in the information storage unit 47 (Step S103). In addition, the external server 300 attaches information indicating the specific task information to the task information being the transmission task of the electronic mail.

In addition, in the document application procedure, as described above, an electronic mail with an attached document may be transmitted at the end of the task in many cases. In the exemplary embodiment, information indicating “termination” is attached to the task information indicating the transmission task of transmitting an electronic mail with an attached document.

In a case where it is not determined in Step S102 that the electronic mail has an attached document, in the exemplary embodiment, information indicating “non-termination” is attached to the task information indicating the transmission task of transmitting the electronic mail (Step S104).

In the exemplary embodiment, in a case where the detection unit 33 detects a plurality of pieces of specific task information, the selection unit 35 selects task information from the plurality of pieces of task information for each piece of the specific task information.

Specifically, a case where the electronic mail with the attached document is transmitted a plurality of times by a plurality of the application task is assumed. In this case, the detection unit 33 detects a plurality of pieces of specific task information.

In this case, the selection unit 35 selects task information from the plurality of pieces of task information for each piece of specific task information included in the plurality of pieces of specific task information.

More specifically, in this case, for each piece of specific task information, the selection unit 35 selects the task information from the plurality of pieces of task information based on the one piece of specific task information.

More specifically, in a case where the selection unit 35 selects the task information from the plurality of pieces of task information based on the one piece of specific task information, from the plurality of pieces of task information, the selection unit 35 selects the task information corresponding to each task which is performed before a specific task specified by the one specific task information and is performed after another specific task before the specific task specified by the one piece of the specific task information and is performed after another specific task performed before one previous task from the specific task.

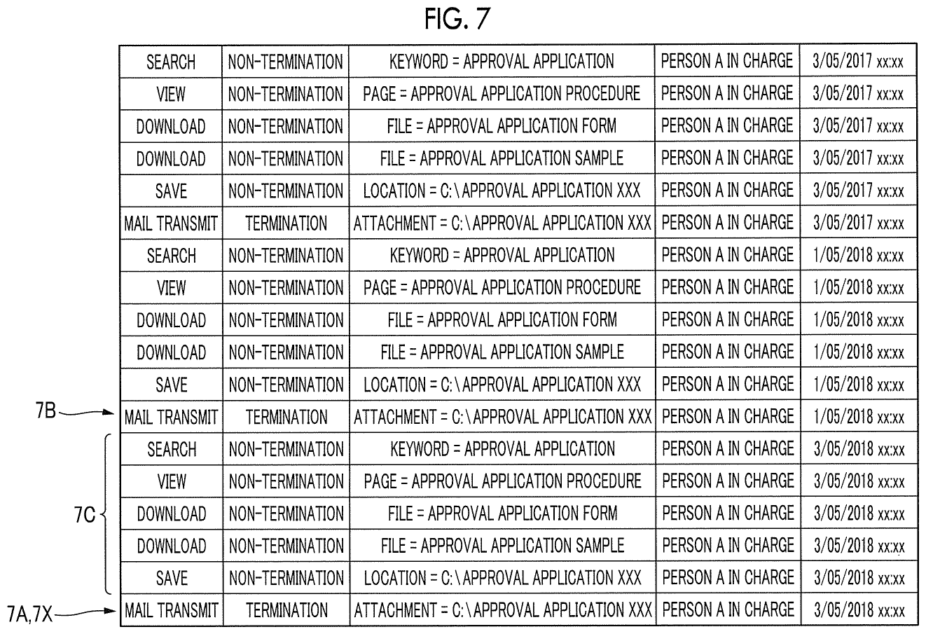

More specifically, for example, in a case where the selection unit 35 selects the task information based on task information corresponding to one transmission of an electronic mail, which is indicated by the reference sign 7A in FIG. 7 (diagram illustrating an example of the task information stored in the information storage unit 47), from the plurality of pieces of task information, the selection unit 35 selects task information (task information indicated by the reference sign 7C) corresponding to each task which is performed before the one transmission of the electronic mail, is performed before one previous task from the one transmission of the electronic mail, and is performed after another transmission of an electronic mail (see the reference sign 7B).

As described above, in a case where the task information is selected for each piece of specific task information, the screen generation unit 37 may generate a display screen on which the task information selected based on the specific task information satisfying a predetermined condition is displayed among pieces of task information selected for pieces of the specific task information.

More specifically, for example, the screen generation unit 37 may generate a display screen on which task information (task information indicated by the reference sign 7C) selected based on the specific task information (specific task information indicated by the reference sign 7A) corresponding to the latest transmission of an electronic mail (electronic mail indicated by the reference sign 7X) among pieces of task information selected for every transmission of the electronic mail is displayed.

In addition, for example, the screen generation unit 37 may generate a display screen on which only task information selected based on specific task information corresponding to a specific task performed the latest among pieces of task information selected for every piece of specific task information is displayed.

Here, in a case where a plurality of pieces of specific task information are detected, and task information is selected for each piece of specific task information, in a case where a display screen on which all pieces of selected task information are displayed is generated, for example, a plurality of tasks similar to each other may be displayed, or the amount of information displayed on the display screen may become excessive.

As described above, in a case where the display screen on which task information selected based on specific task information satisfying the predetermined condition is display is generated, for example, only the latest series of tasks are displayed. Thus, a form in which information to be displayed is narrowed down is obtained, and referring to task information becomes easy.

Here, in the above description, a case where the task information on the task performed by the tasker A is output to the tasker A has been described. However, the exemplary embodiment is not limited to the above case. For example, the task information on the task performed by the tasker A may be output to a person other than the tasker A.

In addition, in the exemplary embodiment, the output unit 43 outputs the task information. In this case, the output unit 43 may output the task information on the tasker A, which has been selected by the selection unit 35, to a person other than the tasker A.

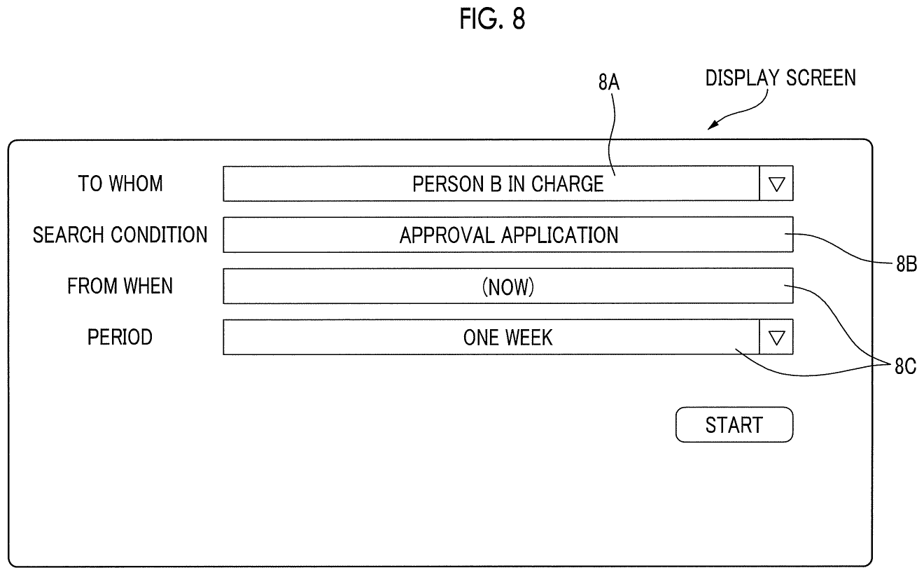

FIG. 8 is a diagram illustrating a display screen displayed on the terminal apparatus 100 of the tasker A in a case where the task information on the tasker A is output to a referrer B who refers to the task information.

An input field 8A for inputting an output destination of the task information, a keyword reception field 8B for receiving a keyword permitting the search of the task information, and a period reception field 8C for receiving a period for permitting the search of the task information are provided on the display screen.

Here, the “keyword permitting the search of the task information” is a keyword to be collated with a keyword input by the referrer B.

In the exemplary embodiment, in a case where the “keyword permitting the search of the task information” coincides with the keyword input by the referrer B, the search of the task information is permitted, and the task information is searched based on the keyword input by the referrer B.

In the above processing example, the search by the referrer B is possible within a period input into the period reception field 8C. The task information selected by the selection unit 35 is output to the referrer B within the period input into the period reception field 8C.

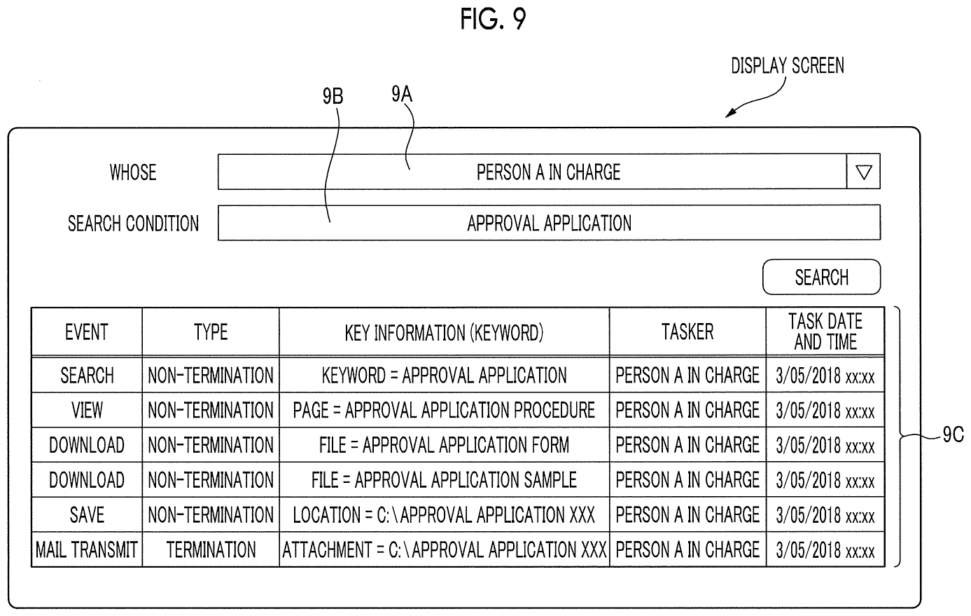

FIG. 9 is a diagram illustrating a display screen displayed on the terminal apparatus 100 of the referrer B.

In a case where the referrer B refers to the task information of the tasker A, a display screen illustrated in FIG. 9 is displayed on the terminal apparatus 100 of the referrer B.

In this example, the information on the tasker A (displayed as “person A in charge” in FIG. 9) is input to a location indicated by the reference sign 9A by the referrer B. In this example, a keyword “approval application” is input at a location indicated by reference sign 9B by the referrer B.

In this case, the above “keyword permitting the search of task information” coincides with the keyword input by the referrer B, and the search is permitted.

In this case, similarly to the above description, the selection unit 35 selects the task information from a plurality of pieces of task information, based on the specific task information detected by the detection unit 33, the keyword input by the referrer B, and the information which indicates the tasker A and is tasker information.

In this case, the task information selected by the selection unit 35 is displayed on the terminal apparatus 100 of the referrer B, as indicated by the reference sign 9C in FIG. 9.

In the display example illustrated in FIG. 9, a case where all pieces of task information on the tasker A (all pieces of task information selected by the selection unit 35) are displayed on the terminal apparatus 100 of the referrer B is illustrated. However, the exemplary embodiment is not limited to the above case. For example, the task information may be protected, and the protected task information may not be displayed on the terminal apparatus 100 of the referrer B.

In addition, the task information on the tasker A, which is designated by the tasker A, may not be displayed on the terminal apparatus 100 operated by a person other than the tasker A.

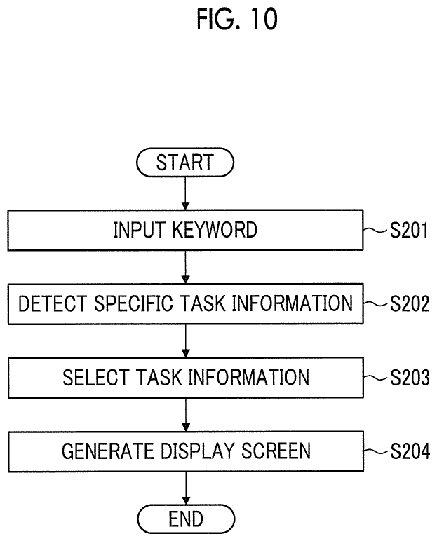

FIG. 10 is a flowchart illustrating a flow of processing performed in a case where processing of searching for task information is performed.

In the processing example, firstly, the terminal apparatus 100 is operated by the tasker A, and a keyword such as “approval application” is input (Step S201).

Then, the keyword and the information (tasker information) on the tasker A are transmitted from the terminal apparatus 100 to the external server 300, and the external server 300 acquires the keyword and the tasker information.

Then, the detection unit 33 in the external server 300 detects specific task information that is task information indicating a specific task, from a plurality of pieces of task information stored in the information storage unit 47 (Step S202).

Then, the selection unit 35 in the external server 300 selects task information from the plurality of task information stored in the information storage unit 47 (Step S203).

Specifically, the selection unit 35 selects task information from the plurality of task information stored in the information storage unit 47, based on the keyword, the tasker information, and the specific task information detected by the detection unit 33.

Then, in the exemplary embodiment, the screen generation unit 37 generates a display screen displayed on the terminal apparatus 100 of the tasker A based on the task information selected by the selection unit 35 (Step S204).

At this time, the screen generation unit 37 rearranges the task information as necessary, such that task information corresponding to the latest task is located at the lowest position, and task information corresponding to a task performed at the earliest timing is located the uppermost position. In addition, the screen generation unit 37 arranges the task information in chronological order.

Then, in the exemplary embodiment, the display screen is transmitted to the terminal apparatus 100 of the tasker A, and the display screen is displayed on the terminal apparatus 100.

Here, in the exemplary embodiment, the editing unit 39 that edits the task information acquired by the task information acquisition unit 31 is further provided. In the exemplary embodiment, the editing unit 39 edits the task information stored in the information storage unit 47 as necessary.

More specifically, the editing unit 39 deletes some pieces of the task information among pieces of task information which have been acquired by the task information acquisition unit 31 and stored in the information storage unit 47, for example.

More specifically, the editing unit 39 deletes the task information selected by the user among pieces of the task information stored in the information storage unit 47.

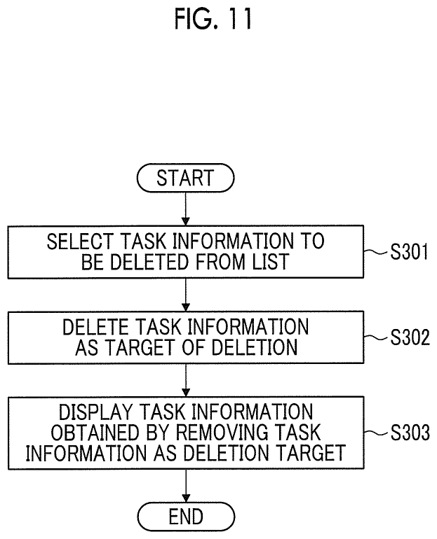

FIG. 11 is a flowchart illustrating a flow of processing performed in a case where the task information selected by the user is deleted.

In a case where there is an attempt to delete the task information, for example, firstly, the user selects the task information to be deleted on the display screen illustrated in FIG. 5 on which the plurality of pieces of task information are displayed (Step S301). In addition, the user selects task information to be deleted from a list of task information.

More specifically, in a case where the user attempts to delete the task information, a selection field for accepting the selection of the task information by the user is displayed, for example, as indicated by the reference sign 5X in FIG. 5. The user selects the task information to be deleted by performing a selection on the selection field.

In the exemplary embodiment, information on the selected task information (referred to as “selected task information” below) is transmitted to the external server 300, and the editing unit 39 in the external server 300 receives the selected task information.

At this time, in the exemplary embodiment, information on the user who has issued a deletion instruction is also transmitted from the terminal apparatus 100 to the external server 300, and the external server 300 also acquires the information on the user.

The editing unit 39 determines whether the user who has issued the deletion instruction is identical to a tasker who has performed a task corresponding to the task information as a deletion target.

In a case where the user who has issued the deletion instruction is identical to the tasker who has performed a task corresponding to the task information as the deletion target, the editing unit 39 deletes the task information as the deletion target (Step S302). In addition, the editing unit 39 deletes the selected task information.

Then, in the exemplary embodiment, task information after the task information is deleted is transmitted to the terminal apparatus 100 of the user who has issued the deletion instruction, and the task information after the task information is deleted is displayed on the terminal apparatus 100 of the user.

In addition, the task information selected by the selection unit 35 is displayed on the terminal apparatus 100 of the user. However, after the task information is deleted, the task information which has been selected by the selection unit 35 and is obtained by removing the task information as the deletion target is displayed (Step S303).

Here, in the process in which the user performs a task, a task other than a task originally required, such as an erroneous task, is often performed.

In this case, as illustrated in FIG. 5, in a case where a list of the task information is displayed, information of a task other than the originally required task is also displayed.

As described above, in a case where deletion of the task information is possible, deletion of the task information indicating the task that is not originally required is possible. Thus, an occurrence of a situation in which unnecessary task information is displayed is suppressed.

In the exemplary embodiment, addition of task information is also possible. In this case, the editing unit 39 adds task information generated based on information input by the user, to the task information acquired by the task information acquisition unit 31.

Here, a more favorable task may be present. Thus, a case where addition of task information indicating the more favorable task is wanted is also assumed. As in the exemplary embodiment, in a case where addition of task information is possible, task information indicating a more favorable task is added.

Here, in a case where there is an attempt to add task information, for example, as indicated by the reference sign 5Y in FIG. 5, a designation field for causing the user to designate a location in which addition of task information is displayed. The user designates an additional position of task information to be added, by performing a selection on the designation field.

Further, the user inputs information on a task that the user wants to add, on an input screen (not illustrated).

Then, in the exemplary embodiment, the editing unit 39 receives the information on the task to be added, and generates task information based on the received information.

The editing unit 39 adds timing information indicating a timing of performing a task specified by the task information to the generated task information, and stores the task information in the information storage unit 47.

More specifically, for example, in a case where the designation field indicated by the reference sign 5Z is designated, the editing unit 39 associates time point information which indicates a time point later than a time at which a task specified by the task information indicated by the reference sign 5C is performed and indicates a time point earlier than a time at which a task specified by the task information indicated by the reference sign 5D is performed, with the added task information. Then, the editing unit 39 stores the added task information in the information storage unit 47.

The editing unit 39 adds a keyword generated based on information input by a user who wants to add task information, such as “approval application”, to the added task information. Then, the editing unit 39 stores the added task information in the information storage unit 47.

Thus, in a case where the added task information is displayed on the terminal apparatus 100, the added task information is displayed between the task information indicated by the reference sign 5C and the task information indicated by the reference sign 5D.

Here, the task information to be added is not particularly limited, and task information of a task performed without using an information processing device such as a PC may be added.

For example, task information such as “contact Mr./Ms. B about the case A by phone” may be added.

As described above, in a case where addition of task information such as “contact Mr./Ms. B about the case A by phone” is possible, an inquiry is transmitted to the partner without using an electronic mail.

(Other)

In the above description, a case where a list of task information is displayed as illustrated in FIG. 5 has been described. However, in addition to the display of the list or instead of the display of the list, for example, task information corresponding to a task to be performed next time by the tasker may be displayed.

In a case where the above processing is performed, the extraction unit 45 extracts task information corresponding to a task to be performed next time by the tasker, from pieces of the task information selected by the selection unit 35.

More specifically, in a case where the above processing is performed, the extraction unit 45 acquires information on a task which has been actually performed by the tasker up to that point, and recognizes task information corresponding to the actually-performed task (referred to as “corresponding task information” below) among pieces of task information selected by the selection unit 35.

Then, the extraction unit 45 extracts task information corresponding to a task after one task from a task specified by the corresponding task information, from the pieces of task information selected by the selection unit 35.

Then, the extracted task information is transmitted to the terminal apparatus 100 of the tasker, and the task information is displayed on the terminal apparatus 100. Thus, the tasker may recognize the task to be performed next.

In addition, the extracted task information may be transmitted to the terminal apparatus 100, and a program required for a task specified by the task information may be automatically executed in the terminal apparatus 100.

Thus, for example, in the terminal apparatus 100, an application required for the next task is started, or a web page required for the next task is displayed.

In addition, the terminal apparatus 100 may automatically perform a task corresponding to the task information extracted by the extraction unit 45.

Specifically, for example, in a case where an input of information is required in a task specified by the extracted task information (referred to as “an extracted task” below), for example, the external server 300 may recognize input information input by the tasker in a case where the extracted task has been actually performed in the past.

More specifically, information stored in association with the extracted task may be acquired from the information storage unit 47, and thus the input information input by the tasker in a case where the extracted task has been actually performed in the past may be recognized.

In this case, the recognized input information is transmitted to the terminal apparatus 100, and the terminal apparatus 100 inputs information identical to the input information, into an information input field on a screen referred to by the tasker. Thus, an input task of the tasker is reduced.

Further, in the exemplary embodiment, a so-called memo may be registered in association with each piece of task information.

More specifically, in the exemplary embodiment, the association unit 41 is provided, and the association unit 41 associates information (referred to as “memo information” below) input by the user, with any piece of task information acquired by the task information acquisition unit 31.

In addition, the association unit 41 associates the memo information input by the user with the task information stored in the information storage unit 47.

More specifically, in a case where the memo information is associated with the task information stored in the information storage unit 47, selection of task information to be associated with the memo information is received through the terminal apparatus 100, and the memo information is received from the user through the terminal apparatus 100.

The external server 300 associates the memo information received from the user with the task information which has been selected by the user and stored in the information storage unit 47.

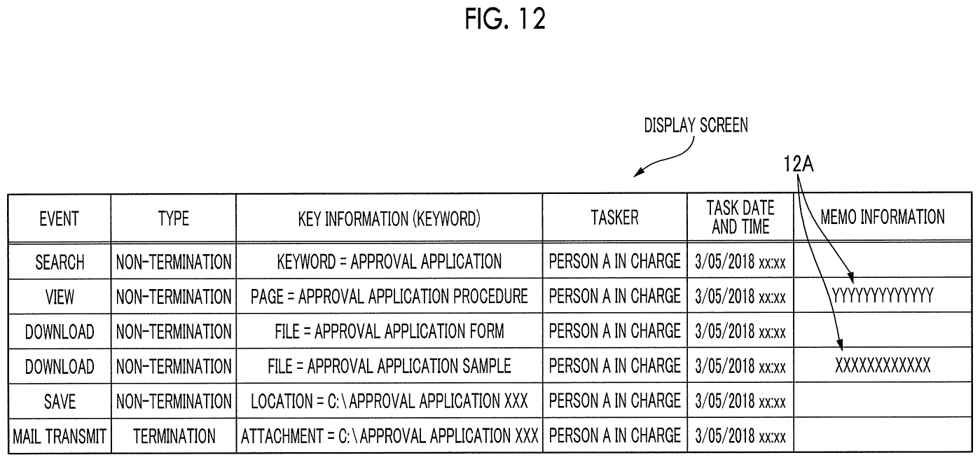

In this case, as indicated by the reference sign 12A in FIG. 12 (diagram illustrating another example of the display screen displayed on the terminal apparatus 100) , in a case where the task information is displayed on the terminal apparatus 100, the memo information associated with the task information may be displayed.

Thus, the tasker may recognize, for example, the notice in the task.

Here, examples of the memo information to be associated include notices in a task.

In addition, examples of the memo information to be associated include information indicating that the task specified by the task information has been performed without being based on the latest rule.

In some cases, the rule for a task is frequently changed. In a case where the information indicating that the task has been performed without being based on the latest rule is associated with the task information as described above, for example, the tasker checks the latest rule, and thus errors in task are reduced.

In addition, examples of the memo information to be associated include a reference destination of a new rule and information of a tasker who has already performed a task under the new rule.

In a case where the information of the tasker who has already performed the task under the new rule is associated, transmission of an inquiry to the tasker is possible. In this case, errors in task are also reduced.

In addition, examples of the memo information to be associated include information on an erroneous task.

Here, in the exemplary embodiment, as described above, deletion of the task information of an erroneous task is possible. In a case where association of the memo information is possible, for example, in a case where the task information of the erroneous task is deleted, the user may associate memo information in which information on the erroneous task is described, with task information indicating a task before one previous task of the erroneous task or new task information added by the user.

More specifically, in this case, the user may associate information of the cause of a mistake in the task, with the task information indicating a task before one previous task of the erroneous task or the new task information added by the user.

In this case, in a case where the tasker performs the task later, the tasker may refer to the information, and thus errors of a task by the tasker are reduced.

In addition, examples of the memo information to be associated with the task information include information on the amount of money required for performing the task specified by the task information.

Examples of the memo information to be associated with the task information include information on another task different from the above task and on the amount of money required in a case where this another task is performed instead of the original task, in addition to the amount of money required for the task.

In a case where information on the amount of money required for performing the task specified by the task information is associated, information on the cost required for the task may be obtained.

In a case where information on another task and information on the amount of money required for this another task are associated with the task information, the other task replacing the task specified by the task information may be recognized. Further, the information on the cost required for this another task may be obtained.

The external server 300 may recognize the required time required for each task (required time required for the task specified by each piece of task information) and the elapsed time between tasks.

In this case, in a case where the task information is selected by the selection unit 35, a required task time required from the start to the end of a series of tasks specified by the task information selected by the selection unit 35 may be recognized.

Further, in a case where the recognized required task time is longer than a predetermined time, and the task requires a long time, a warning may be given to the tasker through the terminal apparatus 100.

Thus, the tasker may recognize whether or not the task is time-consuming.

In addition, for example, identical task information performed in a specific period may be extracted from a plurality of pieces of task information stored in the information storage unit 47, and the user may be notified of the extracted task information through the terminal apparatus 100.

In this case, the user is notified of the task information on a task required for an event held every year and the task information indicating the reservation of a conference room held every month.

In addition, in the exemplary embodiment, as described above, the task information may be deleted. Specific task information which has been frequently deleted may be detected, and the detected task information may be stored in the information storage unit 47 in a state where an access to the task information by a plurality of users is possible.

In this case, the detected task information may be posted in an FAQ or the like as, for example, as “an anti-pattern”. Thus, a frequency that a task specified by the task information is performed is reduced, and an occurrence of a situation in which an erroneous task is performed is reduced.

Further, in a configuration in which deletion of task information is possible as in the exemplary embodiment, an unnecessary task is deleted, and thus it is possible to obtain the minimum task information required for the task.

In the above description, a case where a series of processes for task information are performed in the external server 300 has been described. However, the series of processes described above may be performed in the terminal apparatus 100 of each user.

Apart of the series of processes for the task information may be performed by the external server 300, and the other part of the series of the processes may be performed by the terminal apparatus 100.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a task information acquisition section that acquires task information being information on an individual task performed by a tasker;
a detection section that detects specific task information being task information indicating a specific task, from a plurality of pieces of the task information acquired by the task information acquisition section; and
a selection section that selects task information from the plurality of pieces of the task information acquired by the task information acquisition section, based on the specific task information detected by the detection section.

2. The information processing system according to claim 1,
wherein the selection section selects the task information from the plurality of pieces of the task information, based on the specific task information detected by the detection section and input information being information input by a user.

3. The information processing system according to claim 1,
wherein the selection section selects the task information corresponding to a task performed before a task specified by the specific task information detected by the detection section, from the plurality of pieces of the task information.

4. The information processing system according to claim 1,
wherein, in a case where a plurality of pieces of the specific task information are detected by the detection section, the selection section selects the task information from the plurality of pieces of the task information for each piece of the specific task information.

5. The information processing system according to claim 4,
wherein, in a case where the selection section selects the task information from the plurality of pieces of the task information base on one piece of the specific task information, from the plurality of pieces of the task information, the selection section selects the task information corresponding to a task which is performed before a specific task specified by the one piece of the specific task information and is performed after another specific task performed before one previous task from the specific task.

6. The information processing system according to claim 4, further comprising:
a screen generation section that generates a display screen on which the task information selected by the selection section is displayed,
wherein the screen generation section generates a screen on which the task information selected based on specific task information satisfying a predetermined condition is displayed among pieces of task information selected for each piece of the specific task information.

7. The information processing system according to claim 1, further comprising:
an editing section that edits the task information acquired by the task information acquisition section.

8. The information processing system according to claim 7,
wherein the editing section deletes task information selected by a user among pieces of the task information acquired by the task information acquisition section.

9. The information processing system according to claim 7,
wherein the editing section adds task information generated based on information input by a user, to the task information acquired already by the task information acquisition section.

10. The information processing system according to claim 1, further comprising:
an association section that associates information input by a user with the task information acquired by the task information acquisition section.

11. The information processing system according to claim 1,
wherein the selection section selects the task information from the plurality of pieces of the task information, based on the specific task information detected by the detection section and tasker information being information on a tasker.

12. The information processing system according to claim 11, further comprising:
an output section that outputs the task information selected by the selection section to a person other than the tasker.

13. The information processing system according to claim 12,
wherein the output section outputs the task information selected by the selection section to a person other than the tasker within a predetermined specific period.

14. The information processing system according to claim 1, further comprising:
an extraction section that extracts task information corresponding to a task to be performed next time by a tasker among pieces of the task information selected by the selection section.

15. The information processing system according to claim 1,
wherein the detection section detects task information indicating a task of transmitting a document to an outside among the plurality of pieces of the task information acquired by the task information acquisition section, as the specific task information.

16. An information processing apparatus comprising:
a task information acquisition section that acquires task information being information on an individual task performed by a tasker;
a detection section that detects specific task information being task information indicating a specific task, from a plurality of pieces of the task information acquired by the task information acquisition section; and
a selection section that selects task information from the plurality of pieces of the task information acquired by the task information acquisition section, based on the specific task information detected by the detection section.

17. A non-transitory computer readable medium storing a program causing a computer to realize:
a task information acquisition function of acquiring task information being information on an individual task performed by a tasker;
a detection function of detecting specific task information being task information indicating a specific task, from a plurality of pieces of the task information acquired by the task information acquisition function; and
a selection function of selecting task information from the plurality of pieces of the task information acquired by the task information acquisition function, based on the specific task information detected by the detection function.
